(19) United States
(12) Patent Application Publication
(10) Pub. No.: US 2012/0138369 A1
(43) Pub. Date: Jun. 7, 2012

(54) METHODS TO MANUFACTURE DOWNHOLE TOOLS WITH FINISHED FEATURES AS AN INTEGRAL CAGE

(75) Inventors: Tracy R. Speer, Tyler, TX (US); Dennis Simon, Houston, TX (US); Bruce Nelson, Houston, TX (US); Steven Marek, Houston, TX (US)

(73) Assignee: SMITH INTERNATIONAL, INC., Houston, TX (US)

(21) Appl. No.: 12/961,058

(22) Filed: Dec. 6, 2010

(51) Int. Cl. E21B 10/42; B23P 15/34

(52) U.S. Cl. 175/327; 76/115

(57) ABSTRACT

A method of manufacturing a downhole tool includes machining at least one mill blade integral cage comprising a plurality of mill blades arranged around a central axis and securing the at least one mill blade integral cage on a tool body.

### BACKGROUND

1. Field of the Disclosure

Embodiments disclosed herein relate generally to downhole tools. In particular, embodiments disclosed herein relate to methods to manufacture downhole tools with finished features as an integral cage.

2. Background Art

Traditionally, whipstocks have been used to drill a deviated borehole from an existing earth borehole. The whipstock has a ramp surface which is set in a predetermined position to guide the drill bit on the drillstring in a deviated manner to drill into the side of the earth borehole. In operation, the whipstock is set on the bottom of the existing earth borehole, the set position of the whipstock is surveyed, the whipstock is properly oriented for directing the drillstring in the proper direction, and the drillstring is lower into the well into engagement with the whipstock. This causes the whipstock to orient the drillstring to drill a deviated borehole into the wall of the existing earth borehole.

Previously drilled and cased wellbores, for one reasons or another, may become unproductive. When a wellbore becomes unusable, a new borehole may be drilled in the vicinity of the existing cased borehole or alternatively, a new borehole may be sidetracked from or near the bottom of a serviceable portion of the cased borehole. Sidetracking from a cased borehole is also useful for developing multiple production zones. Sidetracking is often preferred because drilling, casing, and cementing the borehole are avoided. This drilling procedure is generally accomplished by either milling out an entire section of pipe casing followed by drilling through the side of the now exposed borehole, or by milling through the side of the casing with a mill that is guided by a wedge or “whipstock” component.

Current milling tool used for sidetracking operations generally include a tool body having mill blades attached to the tool body and arranged around a circumference thereof. Current manufacturing processes typically include multiple individual steps, including cutting individual mill blades, welding the mill blades to the tool body, and finish machining the mill blades to specific blade geometry. Cumulatively, the individual steps may extend the manufacturing process unnecessarily and increase costs. In addition, the multiple manufacturing steps may be conducive to the inability to maintain proper tolerances of the mill blade features.

Accordingly, there exists a need for a method of consolidating the manufacturing steps required for milling tools used in sidetracking.

### SUMMARY OF THE DISCLOSURE

In one aspect, embodiments disclosed herein relate to a method of manufacturing a downhole tool, the method including machining at least one mill blade integral cage comprising a plurality of mill blades arranged around a central axis and securing the at least one mill blade integral cage on a tool body.

In other aspects, embodiments disclosed herein relate to a milling tool including a tool body and at least one mill blade integral cage disposed on the tool body and comprising a plurality of mill blades arranged around a central axis, wherein the at least one mill blade integral cage is configured to be machined as a separate single component prior to being assembled onto the tool body.

Other aspects and advantages of the invention will be apparent from the following description and the appended claims.

### BRIEF DESCRIPTION OF DRAWINGS

FIG. 1 shows a perspective view of a milling tool in accordance with one or more embodiments of the present disclosure.

FIGS. 2A-2C show perspective and end views of a lead mill blade integral cage in accordance with one or more embodiments of the present disclosure.

FIGS. 3A-3B show perspective views of a follow mill blade integral cage in accordance with one or more embodiments of the present disclosure.

FIGS. 4A-4B show method steps during assembly of the milling tool in accordance with one or more embodiments of the present disclosure.

### DETAILED DESCRIPTION

In one aspect, embodiments disclosed herein relate to methods of manufacturing a milling tool, including machining mill blade integral cages and assembling the mill blade integral cages on a tool body of the milling tool.

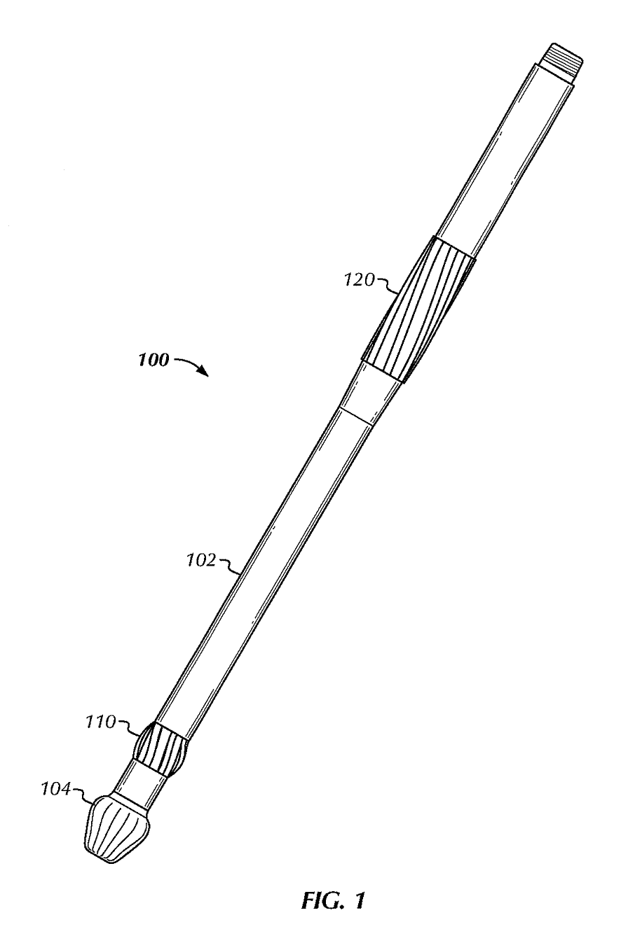

Referring to FIG. 1, a perspective view of a milling tool 100 in accordance with one or more embodiments of the present disclosure is shown. Milling tool 100 includes a tool body 102 having a main head 104 disposed on a distal end thereof, “lead” mill blades 110 disposed slightly up an axial length of the tool body 102 from the main head 104, and “follow” mill blades 120 disposed further up an axial length of the tool body 102 from the lead mill blades 110. In accordance with embodiments disclosed herein, the lead mill blades 110 and follow mill blades 120 may be manufactured as integral components prior to assembly onto the tool body 102.

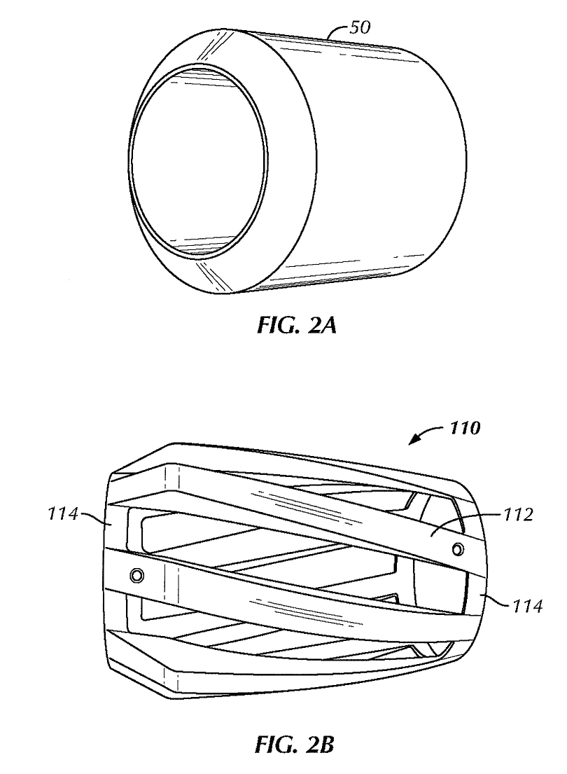

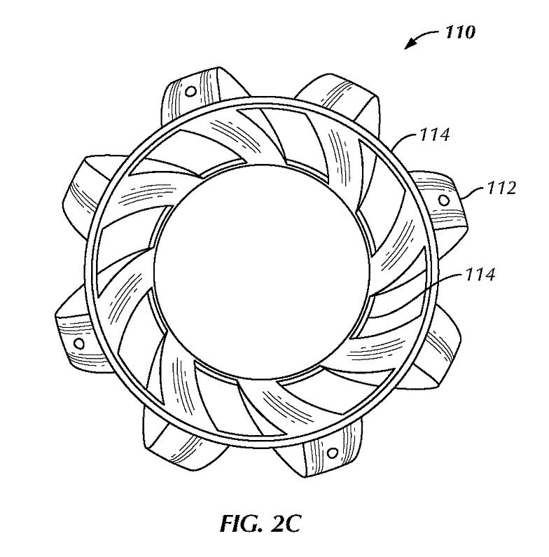

Now referring to FIGS. 2A-2C, perspective and end views of a lead mill blade integral cage 110 in accordance with one or more embodiments of the present disclosure are shown. As shown in FIG. 2B, the lead mill blade integral cage 110 may be machined from tubing 50 (FIG. 2A). In certain embodiments, the tubing may be a low carbon steel, for example, including, but not limited to, AISI 1018-1026. The finish machined integral cage 110 may include individual longitudinally formed mill blades 112 having cutting edges (not shown) formed thereon. As shown, the mill blades 112 may be configured having a slight helix along a longitudinal length of the blades. In addition, the integral cage 110 may include tabs or end rings 114 dispersed circumferentially therebetween at either end. Alternatively, the tabs 114 may form a continuous ring about a circumference at either end of the mill blade integral cage 110. An inner diameter of the finish machined integral cage 110 may be slightly larger than an outer diameter of tool body 102 such that the integral cage 110 just slides over the tool body 102. In certain embodiments, the inner diameter of the finish machined integral cage 100 may be between about 0.010 and 0.020 inches larger than the outer diameter of the tool body 102.

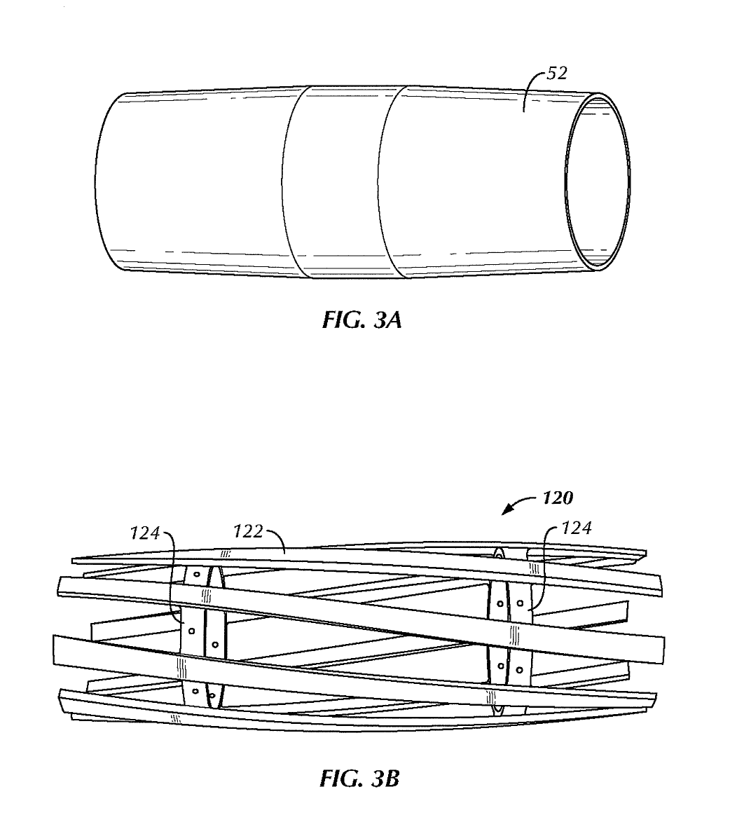

Referring to FIGS. 3A-3B, perspective views of a follow mill blade integral cage 120 in accordance with one or more embodiments of the present disclosure are shown. The follow mill blade integral cage 120 may be machined from tubing 52 (FIG. 3A) and include individual longitudinally formed mill blades 122 having cutting edges formed thereon (not shown). As previously described, the tubing 52 may be a low carbon steel, for example, including, but not limited to, AISI 1018-1026. As shown, the mill blades 122 may be configured having a slight helix along a longitudinal length of the blades. In addition, the integral cage 120 may include tabs or end rings 124 dispersed circumferentially therebetween configured to provide support. In addition, an inner diameter of the finish machined integral cage 120 may be slightly larger than an outer diameter of the tool body 102 such that the integral cage 120 just slides over the tool body 102.

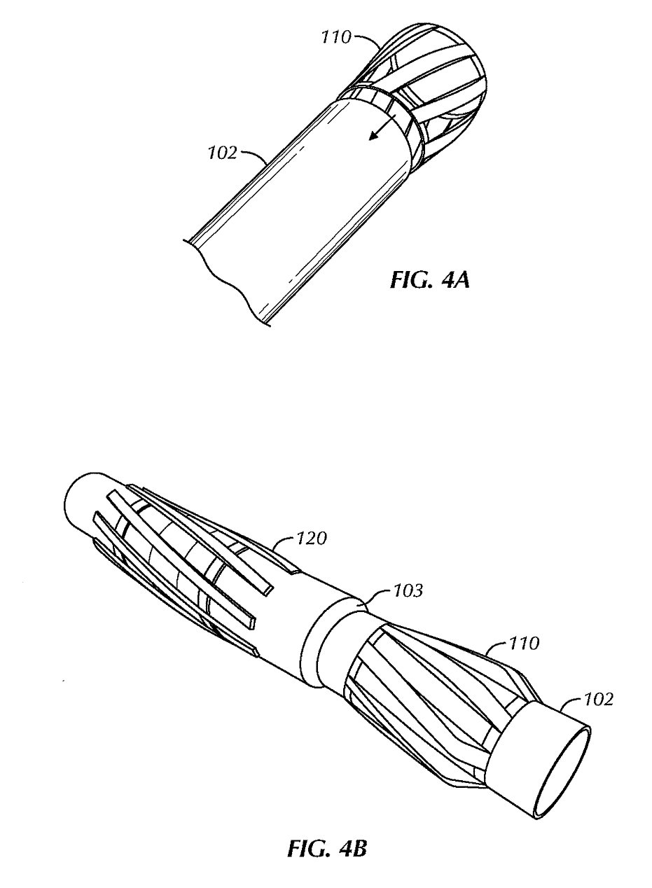

Methods of manufacturing the milling tool in accordance with one or more embodiments of the present disclosure are described in reference to FIGS. 4A-4B. Initially, the tool body 102 of the milling tool 100 may be machined to a specified profile and diameter. For instance, in certain embodiments, a shoulder 103 may be machined in a profile of the tool body 102 where a diameter of the tool body 102 transition to a smaller diameter for the lead mill blade integral cage 110. The shoulder 103 may also be configured to serve as a stop to limit an axial length of the tool body 102 onto which the mill blade integral cage 110 may be installed. Next, the integral cages (i.e., the lead mill blades integral cage 110 and the follow mill blade integral cage 120) may be machined from tubing as a single component. In certain embodiments, a computer numerical control (“CNC”) programming may be used to machine the integral cages 110, 120, as will be understood by those skilled in the art. Once machined, the integral cages 110, 120 may be assembled onto the tool body 102 by sliding the integral cages 110, 120 into the tool body 102, as shown.

The integral cages 110, 120 may be rotated as needed to properly align the integral cages on the tool body. Alignment may refer to an axial alignment (i.e., a certain distance from a bottom end of the tool body 102) and a circumferential alignment (i.e., mill blades orientation as to a left or right hand helix). Once the integral cages 110, 120 are assembled and properly aligned onto the tool body 102, the integral cages and tool body 102 may be preheated and welded to secure the integral cages to the tool body. In certain embodiments, preheat temperatures may be within a range of about 800 degrees Fahrenheit and 1000 degrees Fahrenheit. Any suitable method of welding may be used as known to those skilled in the art. In alternate embodiments, the integral cages 110, 120 may be secured to the tool body 102 using mechanical fasteners or other methods known to those skilled in the art. After the integral cages 110, 120 are secured on the tool body 102, a carbide outer coating or other type of cladding may be applied on surfaces of the integral cages, particularly the weldment and the body area between the mill blades to provide a protective barrier against copper infiltration into the tool body.

Further, the outer surfaces of the mill blades may be dressed with a crushed carbide matrix to create an aggressive cutting profile. Generally the crushed carbide matrix includes a metal cutting grade of carbide crushed to sizes up to ⅜ inch and suspended in a nickel-based matrix. In certain embodiments, a product that is commercially available and known as Kutrite®, available from B&W Metals located in Houston, Tex., may be used. In alternate embodiments, the mill blades may be dressed with cylindrical inserts (made from either steel cutting grade of carbide or PDC) by having holes drilled in the mill blades and inserts brazed in the holes such that the arrangement creates an aggressive cutting profile. Finally, outer surfaces of the integral cages 110, 120 may be ground to smooth any imperfections in weld beads or otherwise.

Advantageously, embodiments of the present disclosure provide more cost effective and faster methods of assembling a milling tool. In particular, methods in accordance with embodiments disclosed herein include fewer manufacturing steps, which increases production and reduces overall manufacturing costs. In certain instances, methods of assembly in accordance with embodiments disclosed herein have reduced manufacturing times by half. In particular, the number of heating/cooling phases previously required may be reduced, which allows improved controlled pre-heat, post-heat, and cool down per certain engineering specifications. The improved heating/cooling control may minimize blade failure (e.g., cracking) due to hot working processes. Further, because the mill blade integral cages are manufactured prior to assembly onto the tool body, more precise geometries may be achieved for the individual mill blades, which may lead to more consistent performance and a reduction in product failures during use. Still further, because the mill blade integral cages are installed as a single unit, they may easily be removed and replaced if required.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A method of manufacturing a downhole tool, the method comprising:
machining at least one mill blade integral cage comprising a plurality of mill blades arranged around a central axis; and
securing the at least one mill blade integral cage on a tool body.

2. The method of claim 1, further comprising welding the mill blade integral cage on the tool body.

3. The method of claim 1, further comprising applying a crushed carbide matrix outer coating on an outer surface of the at least one mill blade integral cage.

4. The method of claim 1, further comprising securing the mill blade integral cage on the tool body with mechanical fasteners.

5. The method of claim 1, further comprising machining the at least one mill blade integral cage using computer numerical control programming.

6. The method of claim 1, further comprising axially and circumferentially aligning the at least one mill blade integral cage.

7. The method of claim 1, further comprising machining a second mill blade integral cage comprising a plurality of mill blades arranged around a central axis and securing the second mill blade cage on the tool body.

8. The method of claim 7, further comprising welding the second mill blade integral cage to the tool body.

9. The method of claim 1, further comprising machining individual longitudinally formed mill blades from a single piece of tubing.

10. The method of claim 9, further comprising machining end tabs dispersed circumferentially between the individual longitudinally formed mill blades.

11. The method of claim 1, further comprising machining an inner diameter of the at least one mill blade integral slightly larger than an outer diameter of the tool body.

12. The method of claim 1, further comprising attaching cylindrical inserts to an outer surface of the mill blades.

13. A milling tool comprising:
a tool body; and
at least one mill blade integral cage disposed on the tool body and comprising a plurality of mill blades arranged around a central axis;
wherein the at least one mill blade integral cage is configured to be machined as a separate single component prior to being assembled onto the tool body.

14. The milling tool of claim 13, wherein an inner diameter of the at least one mill blade integral cage is configured to be slightly larger than an outer diameter of the tool body.

15. The milling tool of claim 13, wherein the at least one mill blade integral cage is configured to be welded to the tool body.

16. The milling tool of claim 13, wherein the at least one mill blade integral cage is configured to be secured to the tool body with mechanical fasteners.

17. The milling tool of claim 13, further comprising a second mill blade integral cage disposed on the tool body and comprising a plurality of mill blades arranged around a central axis, wherein the second mill blade integral cage is configured to be machined as a separate single component prior to being assembled onto the tool body.

18. The milling tool of claim 17, wherein an inner diameter of the second mill blade integral cage is configured to be slightly larger than an outer diameter of the tool body.

19. The milling tool of claim 17, wherein the second mill blade integral cage is configured to be welded to the tool body.

20. The milling tool of claim 17, wherein the second mill blade integral cage is configured to be secured to the tool body with mechanical fasteners.
